(19) United States
(12) Patent Application Publication
(10) Pub. No.: US 2022/0173426 A1
(43) Pub. Date: Jun. 2, 2022

(54) A CASING, BATTERY, A METHOD OF MANUFACTURING A BATTERY AND METHODS OF OPERATING THE BATTERY

(71) Applicant: LEAPAGRO APS, Copenhagen K (DK)

(72) Inventors: Jens Wagonblast Stubbe OSTERGAARD, Roskilde (DK); Johannes Anders SMITH, Copenhagen K (DK)

(21) Appl. No.: 17/614,266

(22) PCT Filed: May 28, 2020
(86) PCT No.: PCT/EP2020/064868

§ 371 Date: Nov. 24, 2021

(30) Foreign Application Priority Data
May 28, 2019 (DK) PA 2019 70350

(51) Int. Cl. H01M 10/04; H01M 50/15; H01M 50/103; H01M 50/547; H01M 50/533; H01M 50/35; H01M 50/474

(52) U.S. Cl. CPC H01M 10/0459; H01M 50/15; H01M 50/103; H01M 50/474; H01M 50/533; H01M 50/35; H01M 50/547

(57) ABSTRACT

A battery with a laminate in which only the anode is exposed at least at one end or side. The laminate may be folded with the anode as the outermost layer. The battery may have a casing with a shoulder portion and an opposite opening for introduction of the laminate. The battery may have a pressure relieve channel extending in a plane of the wall portion. The battery may have a current interruption device positioned at least partly within a concave end cap for saving space.

The present invention relates to improvements in batteries and in particular to improvements in the jelly roll, the rolling, the casing, the battery and its method of operation. The improvements aim to make a battery lighter, cheaper and/or provide the battery with a higher energy density.

In a first aspect, the invention relates to a battery comprising a casing and a charge holding laminate, wherein:

the casing has a first and a second electrical terminal and
the laminate provided in the casing, the laminate comprises at least three layers:
a cathode layer
an anode layer and
a separator provided between the cathode layer and the anode layer,
wherein, in a cross section of the laminate:
the separator forms a U- or V-shaped structure inside which the cathode layer is provided and
the anode layer is provided on both sides of the separator and extend farther in the direction of the bottom of the U- or V-shaped structure than the separator and
wherein the cathode layer is connected to the first electrical terminal of the casing and the anode layer is connected to the second electrical terminal of the casing.

In this context, a battery is an element comprising a chemistry based element capable of creating a current flow. The chemistry based element may be reversible, so that the battery is rechargeable. Otherwise, the chemistry based element may not be so.

In the present battery, the chemistry based element comprises a laminate of at least three layers. More layers may be present, and/or one of the layers may be formed by multiple layers.

The layers of the laminate may be attached to each other but this is not required. The layers need only be adjacent to each other. A liquid, gel, fluid, solid or the like, often called an electrolyte, may be present in or around one or more of the layers. An electrolyte may facilitate ion transport between the layers.

A cathode layer may be a layer capable of receiving electrons. The cathode is the positive pole of a battery when providing a current.

The anode layer may be a layer capable of outputting electrons. The anode is the negative pole on a battery during normal current output.

The separator has the function of preventing direct electrical contact between the anode and cathode layers. Usually, the separator is permeable to ions in order to allow ion transport between the cathode and the anode layers.

The first and second terminals may be a positive and a negative terminal as is usual in batteries. These terminals may be portions of a surface of the casing or may be provided as electrical conductors extending away from the casing. Any type of terminal may be used.

Often, a desired, constant voltage is to be output from a battery. This voltage may, clearly, decrease over time as the laminate is depleted.

The cathode layer is connected to the first electrical terminal of the casing and the anode layer is connected to the second electrical terminal of the casing. This connection may be a direct physical connection or a connection via an element, such as an electrically conducting tab, an electrically conducting, resilient material or the like.

Often, the casing completely encloses the laminate so as to prevent oxygen access to the laminate and/or to protect the laminate from external influences, such as shock, cuts, bending, dents, compression and the like. The laminate operation may be compromised if compressed or bent excessively, if any liquid therein is lost or if oxygen enters the laminate in larger amounts.

The casing may provide an at least air tight enclosure for the laminate.

The casing may be hard, so as to be handled, such as replaced, by consumers, or may be soft, such as a pouch, for handling by professionals and/or for built-in uses in electronic products, such as cell phones, pads, computers, toys, watches, etc. etc.

Naturally, additional elements may be provided within the casing, as will be described below. A number of aspects of the invention relate to both the casing and internal elements of the battery. All aspects, embodiments and situations naturally may be combined in any manner.

According to the invention, the separator forms, in a cross section such as perpendicular to a plane of the separator, a U- or V-shaped structure inside which the cathode is provided. The anode then is positioned outside of the separator structure. In this manner, access to the cathode preferably does not take place from the direction of the bottom of the U- or V-shaped structure.

The anode, on the other hand, extends further in the direction of the bottom of the U- or V-shaped structure, i.e. in a direction from the legs of U or V and toward the bottom thereof.

Then, access to the anode may be simple and it is at the same time ensured that contact cannot be made to the cathode layer. Further below, a number of manners of actually contacting the anode layer are described.

Even though it is not preferred, the anode and cathode layers may be interchanged so that the anode layer is provided in the separator structure.

A number of manners exist of obtaining this structure. In one situation, the separator may be provided as two sheets, one on either side of the cathode, which are then attached to each other, such as by gluing, in order to achieve the desired separation of the cathode from the direction described.

In another, preferred, manner, the laminate, or at least the separator is folded or bent along or around a first axis. The cathode layer may also be folded to obtain a folded, thicker structure. Alternatively, the cathode may be provided as a single, non-folded layer inside the folded separator. The anode may be two layers on either side of the separator or may be provided as one sheet that is also folded. The latter also ensures that the anode layer extends farther in the desired direction, as it is provided there in the first place.

Then, the laminate may have been folded or bent, one or more times, firstly around or along a first axis, or multiple parallel axes, and subsequently along or around a second axis.

The laminate may be folded so that a portion of the laminate overlays another portion of the laminate. In one embodiment, the laminate is folded around a centre axis so that the laminate, when plane, covers about half the area as when not folded.

This folding then has the advantage that the same layer now is on the upper and lower side of the folded laminate—as well as at the folding edge. Multiple manners of folding are known which arrive at the same result—that only the same layer is exposed at the upper and lower sides of the laminate and that at one edge thereof, only that layer is exposed.

Naturally, additional layers may be provided between the two folded portions of the laminate. The two inner-most layers of the laminate may be of the same layer. Between these two layers, a laminate with two layers of separator and the other layer (anode if the two adjacent layers are cathode) may be provided. Alternatively, the cathode layer may be smaller so that the anode layer and separator are folded around the (unfolded) cathode layer.

Then, in order to facilitate introduction of the laminate into the casing, it may, again if already folded, be folded or bent, such as rolled, along a second axis at a non-zero angle to the first axis.

The second folding/bending may be a rolling of the folded laminate. This rolling may be around an axis at an angle to, such as perpendicular to, the first folding axis or to an edge at which only the desired layer is exposed. The final roll will have two end portions and a curved side portion. In this manner, the outer surface of the curved portion of the roll may be of only one of the laminate layers. The same layer may be the only layer exposed at one of the ends, where the folding edge is seen. Thus, connection to this layer may be facilitated, as one end has only that layer exposed.

At the other end, access to the other layer may be provided.

Rolling may be performed in many manners. In one manner, an at least substantially circular cross sectional shape may be sought for. In another embodiment, the so-called prismatic shape is sought for which is more oval or oblong. This shape may be obtained by rolling the laminate over an elongate or oblong bobbin or by folding the laminate around a portion of the laminate that is kept at least substantially straight.

Other battery laminate shapes may be obtained when folded, such as a more plane shape where the rolling is replaced by a folding, such as a Z folding or continued folding. Then, a more flat shape may be obtained which is well suited for non-round battery types, such as box-shaped batteries and pouch batteries. It is noted that a serpentine or z folding with the laminate having the anode layer on the outer side is well suited for e.g. pouch batteries.

In fact, in an alternative embodiment, a number of sub-assemblies each having a cathode layer provided in an enclosure of the separator layer (with a tab extending out therefrom, may be provided and stacked sequentially with anode layers. The separator may enclose the cathode at all 4 sides or 2 sides for example. The anode layers may be contacted at any position, such as using the material or using tabs. The tabs from the cathode layers then form one terminal.

Preferably, at the end opposite to the bottom portion of the U- or V-shaped structure, the separator extends farther than the anode and cathode layers to ensure that the layers do not short circuit at that end. Preferably, the anode layer, in the unfolded laminate, has an outer contour within which an outer contour of the separator layer is seen except at one side surface. Also, preferably, the cathode layer has an outer contour within the outer contour of the separator layer and of the anode layer.

As mentioned, the laminate may be formed as a coil of a folded laminate.

Preferably, the anode layer is outside of the separator and the cathode layer when folded/bent and/or also when rolled.

The casing preferably has a central portion having a cavity or channel with a longitudinal axis and a predetermined cross sectional area in a plane perpendicular to the axis and further comprises:

an opening at one end thereof and a cap portion blocking the opening and forming the first or the second electrical terminal.

One preferred casing type is a tubular structure with a circular cross section.

The cavity or channel preferably has the same cross sectional area/shape along a majority of its length, so that a laminate, preferably rolled, may be introduced into the cavity/channel and occupy that space efficiently.

Naturally, the casing may be made by bending a sheet of a material, such as a metal. Alternatively, deep drawing of the metal may be used for providing the casing or a portion thereof.

Preferably, the laminate is provided through the opening and along a longitudinal axis of the cavity or channel.

The casing may be fully closed at an end opposite to the opening, or that end may also have an opening. This opposite end portion of the casing may then form the other of the first and the second terminal.

Alternatively, both terminals may be formed at the same end.

The opening is closed by a cap portion, which may also form one of the terminals. The cap may be separate to the casing body or may be an integral portion thereof. In one situation, a portion of the casing body is bent or deformed in order to form the cap and close/seal the opening.

In one embodiment, an electrically conducting, resilient material is provided between the other of the cathode layer and the anode layer and the opposite end portion of the casing. In this manner, the electrical contact between the laminate and the terminal may be obtained using this resilient material, greatly facilitating assembly of the battery. This solution is especially relevant at the end of the roll where only one of the layers of the laminate is exposed (at the bottom of the U- or V-shaped structure), such as the end at which an initial bend of the laminate is exposed. In this situation, it will be unproblematic if the resilient material extends into that end of the roll, as there is no risk of short circuiting to the other layer of the laminate.

In fact, the resilient material may be provided also along the sides of the material from the one end and toward the other end, as also the same layer is exposed here. This may enhance both the electrical connection as well as the thermal connection between the laminate and the casing.

This solution may be chosen at either terminal, or both terminals, of the battery.

A resilient material may be a material which is malleable, deformable, mouldable, bendable, soft or the like. Resilient materials may be pastes, puttys, polymers, gels, suspensions, rubbers, or the like PEDOT.

Preferably, the resilient material is also thermally conducting so that heat from the laminate may be transferred to the casing via the resilient material. Naturally, the thermal conductivity is desired as high as possible, but even a small thermal conductivity will be better than none.

Naturally, the resilient material may alternatively or additionally be made of or comprise the same material as that of the exposed laminate layer or be a material supplementing this. For example, this material may counteract any problems caused by bending/folding the anode. The resilient material may perform the anode function at positions where the anode as fissures due to folding. Also, adding anode charge holding material acts to secure the electrochemical balance of the battery.

In one embodiment, the battery further has one or more tab portions extending from at least one of the cathode layer and the anode layer. In the situation where one of the layers is mainly exposed to the outside of the folded/bent/rolled laminate, the tab portions may be attached to the other of the layers (anode or cathode).

Preferably the tab portions are flexible so as to be bendable, such as plastically deformable. In that situation, electrical connection may be obtained by biasing the tab portions toward or to a terminal or an element connected to a terminal.

Naturally, the tab portions may have a surface portion, which is electrically insulating, such as a portion closest to the layer to which it is connected, so as to prevent short circuiting to the other layers. At the farthest end, the tab portions preferably have an electrically conducting surface, such as a metal surface.

The tab portions may be made of any electrically conducting material, such as a metal, alloy or conducting polymers or materials.

The outer ends of the tab portions may be coated or plated in order to ensure a good electrical contact and/or prevent oxidation or the like. Gold plating is one possibility and PEDOT or similar conductive glue are other possibilities as are Nickel and other relatively corrosion resistant metals or alloys hereof.

A second aspect of the invention relates to a method of manufacturing a battery, the method comprising:
1. providing a charge holding laminate comprising at least an anode layer, a cathode layer and a separator layer provided between the anode layer and the cathode layer, wherein, in a cross section of the laminate:
   the separator forms a U- or V-shaped structure inside which the cathode layer is provided and
   the anode layer is provided on both sides of the separator and extend farther in the direction of the bottom of the U- or V-shaped structure than the separator and
2. folding or bending the laminate,
3. providing the folded/bent laminate in a casing having a first and a second electrical terminal,
4. connecting the cathode layer to the first electrical terminal of the casing and the anode layer to the second electrical terminal of the casing.

Naturally, the embodiments and situations described are as relevant in this connection.

As mentioned above, multiple manners exist of arriving at the relevant shape of the laminate and in particular the U- or V-shape of the separator structure. A folding is one manner.

Thus, the folding may be a coiling of the folded/bent laminate, as an alternative to a serpentine or z folding.

In one embodiment, the folding provides the anode layer outside of the separator and the cathode layer.

In one embodiment, step 3 comprises:

providing the folded/bent laminate in a casing having a central portion having a cavity or channel with a longitudinal axis and a predetermined cross sectional area in a plane perpendicular to the axis and providing the folded/bent laminate into the cavity/channel through an opening at one end thereof and the method further comprising the step of blocking the opening with a cap portion forming the first electrical terminal.

Then, the cap portion may form one of the first and second terminals. In that manner, the cap portion may be connected to the anode or the cathode layer.

In one embodiment, an opposite end portion of the casing forms the other of the first and second terminal. Alternatively, both electrodes may be provided at the same end of the battery.

In one embodiment, the anode layer is electrically connected to the casing and the cathode to the cap portion then forming one electrode. In that situation, the other electrode may be formed by any portion of the casing which is electrically connectable from the outside of the battery. In some embodiments, the casing may be covered or coated on the outside by an electrically insulating material which may then comprise an opening or the like for forming the other electrode.

In one embodiment, the method further comprises providing an electrically conducting, and preferably also thermally conducting, resilient, mouldable or mallable, material, such as a paste, gel, putty or the like, between the other of the cathode layer and the anode layer and the opposite end portion of the casing.

In one embodiment, the method further comprises the step of providing one or more tab portions extending from at least one of the cathode layer and the anode layer. As described above, these may be flexible and at least partly covered by an insulating material.

In general, it may be desired to have all electrically conducting elements forming attachments, engagements or the like, such as conducting tabs, end caps and the like, with a gold plating in order to ensure durable electrical contact in the hostile and corrosive environment of a battery.

In a third aspect, the invention relates to a method of assembling a battery comprising a charge holding laminate and a casing, the method comprising:

providing the casing having:
a central portion having a cavity or channel with a longitudinal axis and a predetermined cross sectional area in a plane perpendicular to the axis,
a first end portion adjacent to the central portion, the first end portion forming an inwardly extending shoulder,
a second end portion adjacent to the central portion oppositely to the first end portion, the second end portion comprising an opening into the cavity/channel,
   positioning an electrically conducting cap portion in the cavity/channel and adjacent to the shoulder portion,
   providing a charge holding laminate in the cavity/channel, the charge holding laminate comprising at least an anode layer, a cathode layer and a separator layer provided between the anode layer and the cathode layer,
   electrically connecting one of the anode layer and the cathode layer of the laminate to the cap portion,
   closing the second end portion of the casing and electrically connecting the other of the anode layer and the cathode layer to an electrical terminal of the casing.

Naturally, the above and below aspects, embodiments, situations and definitions are equally applicable in relation to this third aspect.

In this aspect of the invention, the casing has:

a central portion having a cavity or channel with a longitudinal axis and a predetermined cross sectional area in a plane perpendicular to the axis,
a first end portion adjacent to the central portion, the first end portion forming an inwardly extending shoulder,
a second end portion adjacent to the central portion oppositely to the first end portion, the second end portion comprising an opening into the cavity/channel,

The inwardly extending shoulder has the purpose of preventing the cap portion from passing through and out of the cavity or channel. This shoulder may be a collar extending all around an opening at this end of the channel or cavity. Alternatively, the shoulder may be formed by one, two, three, four or more fingers extending inwardly from the outer periphery of the central portion and being distributed around this portion—again to ensure that the cap portion stays within the channel or cavity.

Naturally, the shoulder may be formed by a closure of the cavity, but preferably an opening is provided at that end of the channel in order for the cap portion to be accessible from outside of the battery. Then, the cap portion may form a terminal of the battery.

This cap portion may be provided in the cavity/channel before or after engagement or attachment to the one of the anode layer and the cathode layer. If the connection is an attachment, such as a welding, soldering, gluing or the like, the cap and layer may be attached to each other before introduction into the channel/cavity.

If the engagement is a biasing or the providing of a resilient material, such as a gel, the cap portion may be provided in the channel/cavity before the laminate is introduced therein.

The charge holding laminate is described in detail above. This laminate may be folded or not. Preferably, the laminate is rolled or folded in order to fit in the casing.

Different manners exist of providing electrical connection between the terminals and the laminate layers.

Finally, the second end portion is closed, such as in order to seal the inner cavity/channel to prevent gas exchange between the inner battery and the surroundings.

In one situation, the closing step comprises deforming the second end portion. In this manner, a separate element is not required. The material of the casing may be deformed to close the end portion. This deformation may be a bending of a flap.

In another situation, another end cap may be provided over the laminate at the second end portion, which other end cap may be sealed to the casing, such as by deforming outer portions of the casing or by gluing or the like.

In one embodiment, the step of providing the casing comprises providing a casing having a funnel-shaped second portion. In this manner, this funnel-shape may aid in the introduction of the laminate in the channel/cavity. A tight fit is desired between the laminate and the casing, so a funnel-shape is an advantage.

Subsequently to the introduction of the laminate, the funnel-shaped portion may be removed or bent inwardly to seal that end of the channel/cavity.

The funnel-shaped portion may be positioned at a position outside of the area occupied by the laminate when provided in the cavity/channel. Then, removing that portion would be easy. Alternatively, the laminate may, when positioned in the channel/cavity, extend also inside the funnel-shaped portion which may then be used also for closing the channel/cavity after positioning therein of the laminate.

In one embodiment, the step of providing the casing comprises providing a casing of a polymer, but other materials may be more preferred, such as magnesium, beryllium, titanium, aluminium, or alloys comprising such materials, such as AZ31, or lithium, silicon or the like. Light and strong materials are preferred but may be corrosion prone or the like, so that it may be desired to cover an inner surface thereof with another material. This other material may be a metal/alloy, a polymer or a sol-gel.

In general, the sol-gel process involves the transition of a solution system from a liquid “sol” (mostly colloidal) into a solid “gel” phase. Utilizing the sol-gel process, it is possible to fabricate advanced materials in a wide variety of forms: ultrafine or spherical shaped powders, thin film coatings, fibers, porous or dense materials, and extremely porous aerogel materials.

The starting materials used in the preparation of the “sol” are usually inorganic metal salts or metal organic compounds such as metal alkoxides. In a typical sol-gel process, the precursor is subjected to a series of hydrolysis and polymerization reactions to form a colloidal suspension, or a “sol”. Further processing of the “sol” makes it possible to make materials in different forms.

Interesting parameters of sol-gels may be:
1. High dielectric strength (able to insulate the casing electrically from the battery interior)
2. Hydrophilic (Sol-gels are naturally hydrophilics as metal oxides and this means that the surface of the casing can lubricate itself with liquids behaving similarly to water)
3. Impermeable to battery liquids and especially electrolyte (first line in anti corrosive coating system)
4. Thin layer (it is occupying less prime real estate usable for charge holding material)
5. Fast curing (advantageous for manufacture)
6. Malleable when cured (a higher polymeric content and thinness enables Sol-gel layer to stay attached to casing parts that are put through processes that alter their geometry)
7. Smooth surface (part of the attraction is that Sol-gels fill out nano an micro-cavities of the target they are applied to and enable Jellyroll insertion with minimum frictional stress and subsequent rasping of the jellyroll)
8. Surface reinforcement by filling out nano and micro-cavities with a strong material and thus reduce or remove stress rupture precursors.
9. Surface reinforcement by an added hard layer with high tensile strength and high compressive strength, which makes the casing more resilient inside and outside.
10. Stable surface with high quality glue bonding option.
11. Strong binding upon gold since gold is a preferred any oxygen layer and form a strong connection to both the casing material and the sol-gel.
12. High thermal conductivity (even though the layer is thin and inherently is far more conductive than polymers this attribute comes in handy)
13. Able to integrate nano spheres, Carbon Fullerenes including graphene, Graphene Oxide, Fluorographene, SWCNT's, MWCNT's (both functionalized to increase thermal, mechanical or electric properties) Fluorographene is particularly interesting because it is non conductive and can be functionalized to bond to Sol-gels.

A wide variety of sol-gels are known, such as metal oxide sol-gel coatings (such as SiO₂, ZrO₂. Al₂O₃, TiO₂ and CeO₂) all have very good chemical stability and can provide effective protection. With further development, hybrid films are very promising because they combine properties of the metal oxide material and properties of the ceramic. Incorporation of inorganic nanoparticles can also be a way to include corrosion inhibitors, which create an ‘inhibitor reservoir’ for ‘self-repairing’ coatings that slowly release the inhibitor. The presence of nano-particles also reduces the negative effect of inhibitors on the stability of the sol-gel matrix.

Sol-gel has the advantage that it may achieve its function with a thickness which is orders of magnitude thinner than the required layer thickness of polymer or gel, thus liberating space for more of the laminate. Actually, the space savings may allow an additional full revolution of the laminate which is a large improvement.

Also, sol-gels exist which have exceptional dielectric strength and orders of magnitude better thermal conductivity than polymers and gels. Sol-gel makes it possible to use casings of materials such as Lithium Aluminium alloys or magnesium alloys which are widely used in aviation.

One purpose for this coating may be to protect the laminate against any rough inner surface of the casing. Some casings are deep drawn steel casings. Deep drawing creates stress fissures in the material creating a coarse inner surface threatening to break the outer layers of the laminate.

Another reason could be to prevent electrical connection between the laminate and the casing.

Yet another reason may be to prevent ion transport between the laminate and the casing material. The chemistry of the laminate may react with other materials and this may cause a deterioration of the operation of the laminate and may cause oxidation or corrosion of the casing material.

Thus, depending on the desired function of the coating, different materials may be used.

In one embodiment, the step of providing the casing further comprises providing the casing with an outer, corrosion/oxidation preventing layer, which may be a metal/alloy or a sol-gel, for example. Some of the above-mentioned casing materials are more light-weight than steel and thus highly desirable for that reason. However, these materials are corrosion prone and thus may be desired protected. An outer coating may be employed to that effect.

It may be desired to provide the end cap of e.g. an electrically conducting material so as to act as a terminal. Then, the casing material need not be electrically conducting or may be covered by an electrical insulator.

In one embodiment, the method of providing the casing comprises cutting a tube-shaped element into a plurality of casing preforms and subsequently machining each casing preform to form a casing therefrom.

An advantage of an originally tube-shaped element is that such elements tend to have smoother inner surfaces than deep-drawn elements. Also, not all materials lend themselves to deep-drawing. Thus, allowing the use of tube-shaped elements both makes the production cheaper and relaxes the requirements of any additional coating of the inner surface.

The machining is the providing of e.g. the shoulder portion. This portion may be provided by a deformation of the tube-shaped preform or by the addition of the shoulder portion such as by soldering, welding, gluing or the like.

Also, the outwardly flaring portion may be provided, such as by deformation of the tube-shaped preform.

As mentioned above, the providing of the laminate may comprise proving a charge holding laminate having one or more tab portions extending from at least one of the anode layer and the cathode layer, and wherein the step of electrically connecting the one layer to the cap portion comprises providing electrical contact between one or more of the tabs and the cap portion. As described above, the tab portions may be flexible and covered at least partly by an insulator.

Preferably, the method further comprises the step of electrically connecting the other of the anode layer and the cathode layer to an electrical terminal of the casing. This terminal may be an end portion of the casing. The terminals of the battery may be at opposite ends thereof or the same end. In both cases, the laminate may be connected to the terminal via the casing material.

The step of electrically connecting the other of the anode layer and the cathode layer to the electrical terminal then may comprise providing an electrically conductive and resilient material between the other layer and the end portion. In that manner, soldering or the like is not required. The resilient material may be compressed to ensure the electrical contact.

In a fourth aspect, the invention relates to a casing for use in the method of the third aspect of the invention, the casing having:

a central portion having a cavity or channel with a longitudinal axis and a predetermined cross sectional area in a plane perpendicular to the axis,
a first end portion adjacent to the central portion, the first end portion forming an inwardly extending shoulder,
a second end portion adjacent to the central portion oppositely to the first end portion, the second end portion comprising an opening into the cavity/channel, and an electrically conducting cap portion in the cavity/channel and adjacent to the shoulder portion.

As described above, the cavity or channel preferably has the same cross sectional area or shape along at least a majority of its length in order for a cylindrically shaped laminate (with the same area or shape in a plane perpendicular to a longitudinal axis) to snugly fit inside the channel/cavity.

The shoulder or collar is provided at one end for preventing the end cap from moving from the channel/cavity and outside of the channel/cavity. The shoulder or collar may be a circumferential element or a number of individual projections extending from a periphery and inwardly at the first end portion.

If the channel/cavity is circular, it will have an inner diameter. The cap may then be circular and have an outer diameter corresponding closely to the inner diameter, and the shoulder may define therein an opening having a largest dimension, which is smaller than the diameter of the cap portion.

The second end portion has the opening through which the laminate may be introduced into the channel/cavity. The casing may have a funnel-shaped second portion, such as at the second end portion in order to facilitate introduction of the laminate into the cavity/channel.

Preferably, the cap seals against the casing so as to form an air tight seal. The cap may seal against the shoulder portion and/or the inner wall of the casing. This seal may be obtained in a number of manners, such as by adding a seal or gasket, by gluing, press fitting, deformation of the casing material or the like.

As mentioned above, the casing may be made of a metal or alloy. Preferably the casing is made of a light material, such as of a polymer, but other materials may be more preferred, such as magnesium, beryllium, titanium, aluminium, or alloys comprising such materials, such as AZ31, or lithium, silicon or the like. Light and strong materials are preferred but may be corrosion prone or the like, so that it may be desired to cover an inner surface thereof with another material. This other material may be a metal/alloy, a polymer or a sol-gel. A wide variety of sol-gels are described above.

In addition, it may be desired that the casing comprises an outer, oxidation or corrosion preventing layer, such as a metal, such as nickel, or gold, or a sol-gel.

The casing may further comprise a charge holding laminate, as described above, folded or not, preferably rolled and positioned in the cavity/channel, wherein one of the anode layer and the cathode layer of the laminate is electrically connected to the cap portion. The cap portion then may form a terminal of a battery comprising the casing and laminate.

The end cap may be attached to the laminate before introduction into the channel/cavity or after. The connection may be obtained via tabs as described above and below or via an electrically conducting, resilient element. Alternatively, the laminate may itself be biased against the cap, optionally with a conducting, resilient material between the laminate and the cap.

As described above, the charge holding laminate may have one or more tab portions extending from at least one of the anode layer and the cathode layer and being in electrical contact with the cap portion.

Alternatively, the connection may be provided using the above-mentioned resilient material. Naturally, these solutions may be used in relation to any of the anode and cathode layers.

In a fifth aspect, the invention relates to battery comprising the casing according to the fourth aspect, the battery further comprising a charge holding laminate provided in a cavity or channel of the casing.

In a sixth aspect, the invention relates to a battery provided by the method according to the third aspect, the battery comprising:

a casing having:
a central portion having a cavity or channel with a longitudinal axis and a predetermined cross sectional area in a plane perpendicular to the axis,
a first end portion adjacent to the central portion, the first end portion forming an inwardly extending shoulder,
a second end portion adjacent to the central portion oppositely to the first end portion, the second end portion comprising an opening into the cavity/channel,
   an electrically conducting cap portion in the cavity/channel and adjacent to the shoulder portion, and
   a charge holding laminate in the cavity/channel, the charge holding laminate comprising at least an anode layer, a cathode layer and a separator layer provided between the anode layer and the cathode layer,
   where one of the anode layer and the cathode layer of the laminate is electrically connected to the cap portion, and
   the second end portion of the casing is closed by a second end cap electrically connected to the other of the anode layer and the cathode layer.

The second end portion may be formed by another end cap which may be attached to the casing. Alternatively, the second end portion may be formed by a portion of the casing which is deformed or machined to close and/or seal the second end portion.

As mentioned, one manner of electrically connecting a layer, such as an outer layer of the laminate, such as at an end thereof, is to provide an electrically conductive and resilient material electrically connecting the second end cap to the other layer.

In a seventh aspect, the invention relates to a battery with a casing and a charge holding laminate, the casing comprising an inner cavity closed at one end by an electrically conducting cap portion electrically connected to a layer of the laminate,

the battery further comprising a wall part and a vent element formed in the wall part, the vent element comprising a channel having a first opening and a second opening, the first opening opening into the cavity, the second opening opening toward surroundings of the battery and at least a portion of a length of the channel extending at least substantially in a plane of the wall part.

In the present context, the wall part may be any part of the casing in which the laminate is provided. The wall part may be plane or curved.

The channel may have two or more openings. Preferably, the first and second openings are at opposite ends of the channel. The channel facilitates gas transport between the inner cavity and the surroundings, such as when a pressure difference between the inner cavity and the surroundings exceeds a predetermined limit. Overpressure in the cavity of a battery may occur if the laminate temperature exceeds a limit where gasification of components of the laminate takes place. Increased temperature may also be seen when excessively charging or discharging the laminate and in particular when charging a laminate already charged above a threshold or discharging a laminate discharged below a threshold, as ion transport in these situations create more heat than otherwise.

An elevated temperature increases the pressure in the battery. A too high pressure may cause an explosion and should be relieved in a controlled manner.

Clearly, the channel dimensions may be selected so that a sufficiently high gas flow is possible at a sufficiently high pressure difference between the two openings. On the other hand, it may be desired that any gas flow in the channel is absent or at least below a limit at lower or no pressure difference. A longer channel naturally will prevent or limit the gas flow as will a narrower channel.

In order to gain a larger freedom to design the channel, at least a part of the channel extends in and/or along a plane of the wall part. The wall part may be plane so that the plane in which the at least part of the channel extends may be flat. Alternatively, the wall part may be curved so that the channel follows a curved path. In this manner, any length and cross sectional area of the channel may in principle be used. In addition, the channel may have any cross sectional shape and area, which may vary over the extent of the channel if desired.

That the portion of the channel extends in a plane may mean that a longitudinal direction of at least a portion of the channel extends at least at a non-perpendicular angle to a surface of the wall part at this part of the channel. Preferably, for at least a portion of the channel, a central axis extends at least substantially parallel to the plane.

It is noted that the channel may be curved or meandering while extending in or along the plane.

The present channel and the openings may be provided in any portion or part of the battery casing, such as in the casing wall or the end cap. Multiple channels may be provided if desired.

The channel dimensions may themselves be selected so that the gas flow is as desired when the pressure difference between the first and second openings when the pressure difference is negligible and above a threshold, respectively.

This threshold may be adapted to the laminate and in particular the electrolyte which is often the problematic element. Typical electrolytes have a tendency of becoming gaseous when heated or exposed to external pressure. This gasification clearly increases the internal pressure and should be relieved.

If the temperature becomes even higher, the separator may become damaged, such as by melting and thus closing the openings therein, so that ion transport is no longer possible. Then, the damage is irreversible.

It may be desired to provide, in the channel, a fluid, gel or solid material which may be pushed out of the channel by a sufficiently high pressure difference between the first and second openings.

As mentioned, an excessive pressure difference usually is caused by an excessive temperature. Thus, the material may have a predetermined melting or evaporation temperature, which can be adapted to the electrolyte. Usual temperatures may be in the interval of 85-120° C.

Then, the material may change phase and thus be more easily removed from the channel.

Having removed the material from the channel may be seen as a problem in that the channel then may be more open and thus allow a too large gas transport also when the pressure difference is insignificant.

A manner of addressing this is when the battery further comprises one or more reservoirs provided in the wall part, each reservoir having a single opening, each single opening opening into the channel.

In this manner, a part of the material may be forced into a reservoir instead out of the channel. Then, when the pressure difference has normalized, the material of the reservoir may be forced out of the reservoir and back into the channel to re-seal the channel. In this manner, re-sealing of the channel may be obtained at least once.

In one embodiment, the reservoir has only one opening, so that when material is forced into the reservoir, the pressure in the reservoir increases. When the pressure in the channel decreases, the overpressure in the reservoir will force the material back into the channel.

Clearly, the pressure in the channel will vary with the position in the channel. Close to the second opening, the pressure is lower than at the first opening which is at the overpressure. Thus, the position of the opening to the reservoir will define the pressure available for forcing the material into the reservoir.

Clearly, the material is forced outwardly in the channel. Then, at least some of the material should be positioned between the first opening and the opening toward the reservoir. Then, the material positioned between the second opening and the opening to the reservoir may assist in forcing material into the reservoir.

Thus, the amount of material between the opening to the reservoir and the first and second openings, respectively, may be selected to ensure that a sufficient amount of material is forced into the reservoir before the remaining material is ejected from the channel to allow the gas flow to commence to relieve the gas overpressure.

Material may additionally or alternatively be drawn from the reservoir to the channel due to the capillary effect.

Naturally, this pressure relieve channel may be used in connection with any of the other aspects of the invention. In fact, in one embodiment, the pressure relieve channel may form a weakening of the surface part in which it is provided. Then, if the pressure relieve channel is not able to reduce the pressure in the casing, the surface part may break at the channel so as to, irreversible, relieve the pressure in a controlled manner. This is an alternative to a battery exploding.

Naturally, the channel and optionally also the reservoir may be provided in a number of manners. One manner is to provide the wall portion in multiple layers, one of which has the channel/reservoir provided therein, such as when the casing portion is provided as two portions defining between them the channel. The two portions may comprise engaging surfaces and one or both surfaces may comprise therein the channel as a groove. The openings may be provided during or after providing the portions or the groove(s).

In an eighth aspect, the invention relates to a method of producing a battery according to the seventh aspect, the method comprising providing a casing comprising an inner channel or cavity closed at one end by an electrically conducting cap portion electrically connected to a layer of the laminate and a casing portion,

wherein the step of providing the casing portion comprises:
providing a first portion part with a first opening, the first opening opening into the cavity,
providing a first material on the first portion part, the first material extending from the first opening,
providing a second material on the first portion part and the first material and with a second opening at the first material, the second opening opening toward the surroundings of the battery.

In this context, the first portion part may be a moulded part capable of supporting the first material which will define at least part of the channel. The first material may be the above material blocking the channel until gas flow is desired.

The first material extends from the first opening so that gas flow is possible from the first opening to the first material.

The second material is provided on the first material and the first part. The second material preferably does not replace or displace the first material to any significant degree so that the first material may define the channel. The second opening opens to the first material so that gas flow is possible from the second opening to the first material.

The first material may be removed subsequently to allow the channel to be open. Alternatively, the first material may be as the material described above which evaporates or melts at a sufficiently high temperature.

The providing of the second material may be a moulding process where the second material is moulded on to the first portion part and the first material. The first portion part and the first material may be provided in a mould into which the second material is fed.

Naturally, the dimensions of the channel may be as described above.

In addition, one or more reservoirs may be provided. A reservoir may be provided which is initially empty and thus ready to receive material. In another embodiment, the reservoir may be manufactured already comprising material which may then replace material originally in the channel and which is ejected during venting. Then, the reservoir may generally be manufactured in the same manner as the channel.

A ninth aspect of the invention relates to a method of venting gas from an inner cavity of a battery, the method comprising venting the gas to surroundings of the battery via a vent element formed in a wall part of the battery, the vent element comprising a channel having a first opening and a second opening, the first opening opening into the cavity, the second opening opening toward the surroundings of the battery and at least a portion of a length of the channel extending at least substantially in a plane of the wall part.

In one embodiment, the battery further comprises a solid, gel or liquid material with a predetermined melting or evaporation temperature in the interval of 85-120° C., depending e.g. on the electrolyte, the material being positioned in the channel, the method comprising the step of heating the material to above 85 degrees and ejecting at least a part of the material to the surroundings.

In one embodiment, the battery further comprises one or more reservoirs provided in the wall part, each reservoir having a single opening, each single opening opening into the channel, and wherein the method comprises displacing material into at least one of the reservoirs during venting. This embodiment may also comprise, upon cooling of the battery, re-introduction of material from the reservoir into the channel and cooling and re-solidification (or conversion back into gel/liquid) thereof to, preferably, re-seal the channel.

In a tenth aspect, the invention relates to a battery comprising:

a concave end cap,
a casing having an opening closed by the end cap, the end cap having a cavity facing an inner space of the casing,
a charge holding laminate in the casing, the charge holding laminate comprising at least an anode layer, a cathode layer and a separator layer provided between the anode layer and the cathode layer, and
a thermal switch comprising:
a connection portion electrically connected to one of the anode layer and the cathode layer and being configured to move between a first position and a second position, where, in the first position, the connection portion is electrically connected to the end cap within the cavity, and in the second position, the connection portion is at a at least a predetermined distance from the end cap so as to not be electrically connected to the end cap, and
a thermally reactive element configured to position the end connection portion in the first position when the temperature is below a threshold temperature and in the second position when the temperature is above the threshold temperature.

In this context, the end cap is concave seen from inside the battery, so that a cavity is provided which may be used by the switch. The end cap is engageable or exposed from/to outside of the battery to form a terminal thereof.

The cavity may have a size sufficient for both the first and the second positions to be provided therein. Also, the thermally reactive element, or at least a part thereof, may be positioned therein. Even then, the cavity may be determined by a desired convex outer shape of the end cap in order to have the desired shape as an end cap of the battery. In that manner, the size of the cavity is utilized optimally and not merely lost.

The laminate may be as described above or a standard rolled un-folded laminate. Naturally, any chemistry and technology may be used.

The connection portion is electrically connected, such as physically abutting, soldered/welded/glued to or the like, one of the layers of the laminate so as to be able to receive/deliver current therefrom/to.

Also, the connection portion is configured to be moved between the first and second positions where, in the first position, connection portion is electrically connected to the end cap so that the end cap may receive/deliver the current. This is the operative mode of the switch and the battery.

The connection portion may be moved into a second position where the distance exists to the end cap, so that a current is no longer possible. Thus, the two positions have different distances to the end cap. In addition, the connection portion may, in the second position, be closer to the laminate than in the first position.

A thermally reactive element is provided for moving the connection portion between the two portions. The thermally reactive element performs the movement based on a temperature thereof, so that when the temperature is sufficiently low, the thermally reactive element keeps the connection portion in the first position so that the battery is active. When the temperature rises above the threshold temperature, the thermally reactive element moves the connection portion to the second position and thus breaks the electrical connection.

Allowing current flow at such high temperatures may cause the battery to explode.

The thermally reactive element may be made of any type of material which changes a dimension, shape or the like with temperature, such as 85 degrees or less, such as 80 degrees or less, such as 75, 70, 65, 60, 55 or 50 degrees or less.

In one situation, the thermally reactive element is attached in relation to, such as directly to, the casing at a position between the end cap and the laminate. Then, movement of the connection portion may be relative to the casing. Forces applied by the thermally reactive element may be applied to the casing and not to e.g. the laminate.

The thermally reactive element may be configured to move, when the temperature exceeds the threshold temperature, the connection portion from the first to the second position and remain in that position even when the temperature drops below the threshold temperature again. Then, the thermally reactive element may require a physical interaction, such the application of a pressure or force, to move the connection portion back into the first position. Then, the battery is kept out of production until actively engaged again.

This external force may be applied to the concave end cap which may be mounted with a resilient insulation in order to allow this depression.

Naturally, the thermally reactive element or another element may be biasing the connection portion toward the first or second position so that the thermally reactive element may release or counteract that biasing to allow the movement to take place at the elevated temperature.

In another embodiment, the thermally reactive element is configured to move the connection portion from the first position to the second position and back to the first position. Then, once the battery has cooled sufficiently, the battery is again brought into the operative mode.

Materials suitable for use as the thermally reactive element may be bi-metallic actuators which are a configuration of two different metals with different thermal expansion. A classical metal pair is Copper/steel and others include iron-nickel bimetallic actuator. Another candidate type is memory polymers which and include par example shape-memory polymers (SMPs), which includes thermoplastic and thermoset polymers, which means the production can both be standard plastic moulding of thermoplastics and by curing a thermosetting viscous liquid prepolymer or resin, often called a thermoset, that irreversibly hardens to the desired shape in a mold.

It may be desired to provide an insulating material between the end cap and the casing material, as the casing may be connected to the anode and the end cap to the cathode or vice versa. Materials suitable for this use may be relatively standard hydrophobic polymer impermeable to water, such as PET, polycarbon or polyester. Mylar, for example, would be suitable to obtain both the desired strength, low thickness, low weight, low thermal expansion and high melting point, which for mylar is around 254° C. Mylar has a thermal expansion of only 0.6% between 20° C. to 105° C. A metal layer may be added or integrated (such as printed) to act as an oxygen barrier, such as aluminium and/or gold.

Naturally, this CID may be combined with a high pressure relieving element such as a controlled fracturing. If the pressure becomes excessive, a surface of the battery casing may have a scored or otherwise weakened portion which may break due to the pressure to relieve the pressure without the battery exploding.

In an eleventh aspect, the invention relates to a method of switching of a battery when overheating, the method comprising:

providing a battery comprising:
a concave end cap,
a casing having an opening closed by the end cap, the end cap having a cavity facing an inner space of the casing,
a charge holding laminate in the casing, the charge holding laminate comprising at least an anode layer, a cathode layer and a separator layer provided between the anode layer and the cathode layer, and
a thermal switch comprising a connection portion, in electrical contact with one of the anode layer and the cathode layer, and a thermally reactive element configured to move the connection portion,
   the method comprising:
   when the temperature is below a threshold temperature, the thermally reactive element positions the connection portion in a first position in electrical contact with the end cap in the cavity thereof and
   when the temperature is above the threshold temperature, the thermally reactive element positions the connection portion in a second position in which it has at least a predetermined minimum distance to the end cap so as to not be electrically connected to the end cap.

As mentioned above, the method may comprise the step of the thermally reactive element being heated and moving the connection portion from the first position to the second position. This movement may take place when the temperature exceeds a threshold temperature as mentioned above.

As mentioned, the method may additionally comprise the subsequent step of the thermally reactive element being cooled and moving the connection portion from the second position to the first position.

The method may alternatively comprise the step of a force being applied to the battery to force the thermally reactive element to have the connection portion move back to the first position.

In the following, preferred embodiments of the invention will be described with reference to the drawings, wherein:

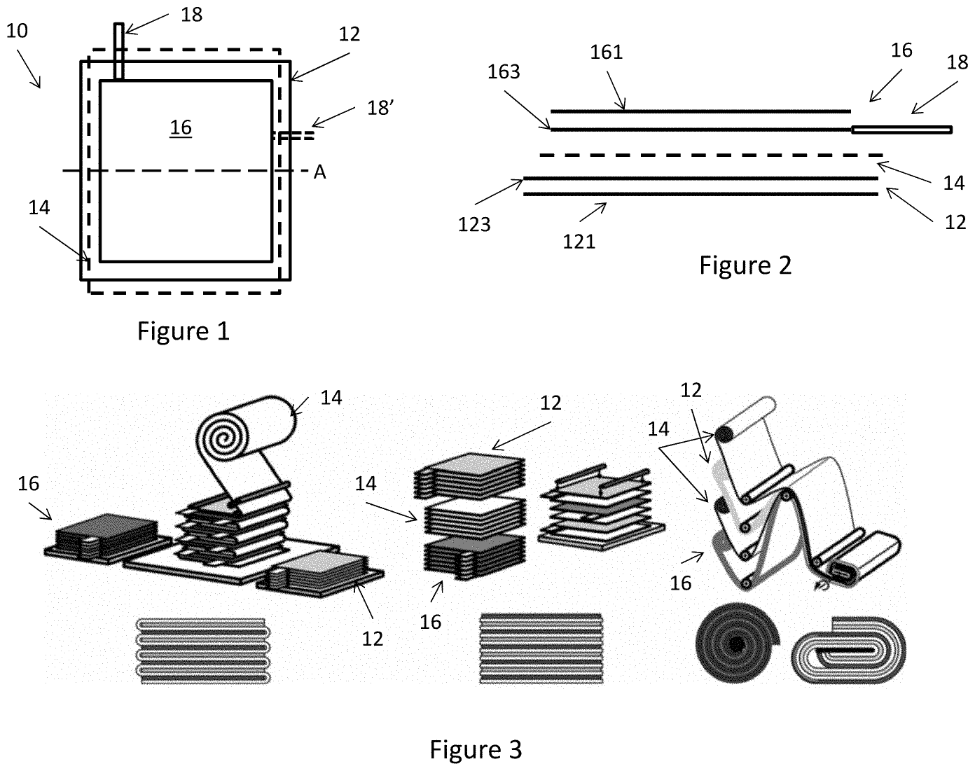

FIG. 1 illustrates the layers of a charge holding laminate,

FIG. 2 illustrates additional layers of the laminate,

FIG. 3 illustrates how to stack/roll the laminate for a battery,

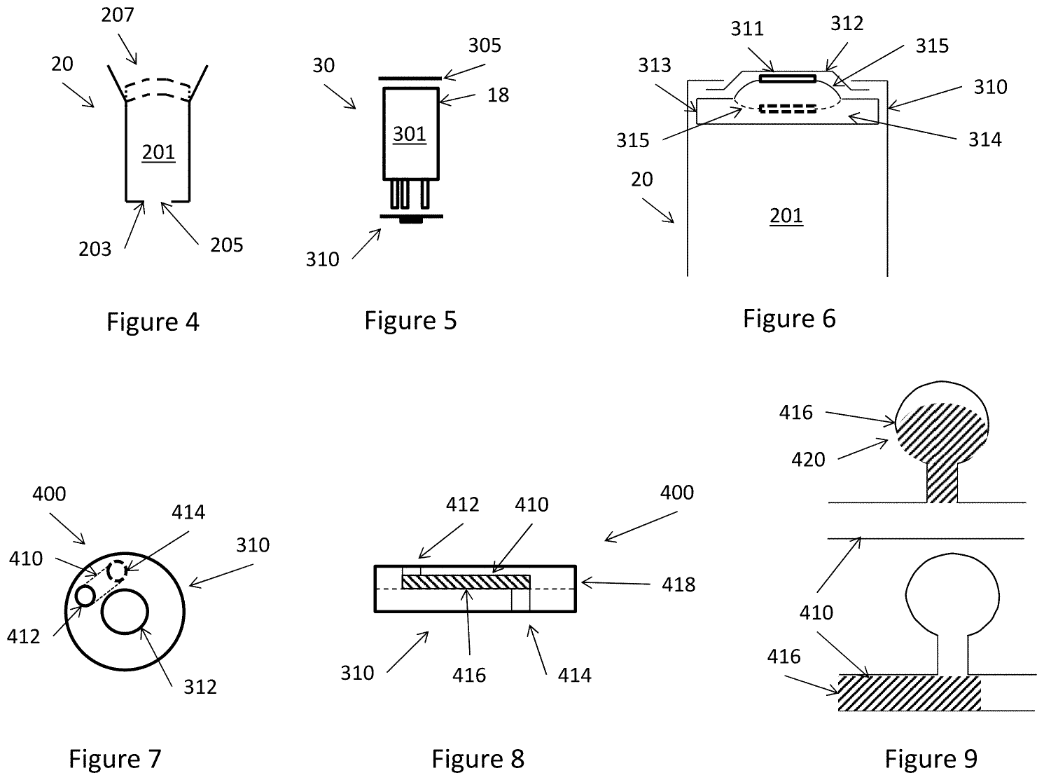

FIG. 4 illustrates a preferred casing type,

FIG. 5 illustrates a rolled laminate with end caps,

FIG. 6 illustrates a Current Interruption Device,

FIG. 7 illustrates a vent in an end cap,

FIG. 8 illustrates a cross section of a vent,

FIG. 9 illustrates a reservoir for use in a vent,

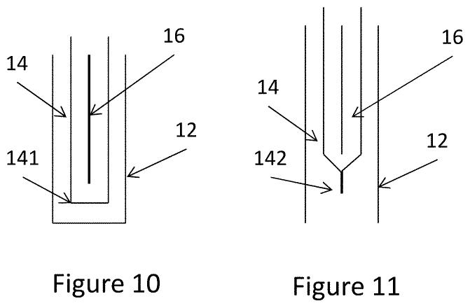

FIG. 10 illustrates an embodiment of a folded laminate, and

FIG. 11 illustrates an embodiment with combined separator layers.

In FIG. 1, a charge holding sheet or jelly roll sheet 10 is illustrated having, as is usual, an anode layer 12, a separator layer 14 and a cathode layer 16. A conductive tab 18 is connected to the cathode layer.

In FIG. 2, a typical build-up of the layers is seen, where the anode 12 comprises a current collector material 121, such as aluminium an anode material 123, and where the cathode 16 comprises a current collector material 161, such as cupper and a cathode material 163.

A very large number of anode and cathode materials exist. The present invention is not limited to a particular battery chemistry.

Usual anode materials may be:
Lithium titanium oxide (Li₄Ti₅Oi₂; LTO)
Carbon-coated lithium titanium oxide (C-LTO)
Silicon-graphite (Si—C) composites with different mass ratios
Silicon monoxide nanowire (SiOₓ—NW)
Silicon monoxide nanowire-graphite (SiOₓ—C) composite
Tin oxide (SnO₂)/doped tin oxide
Graphite
Cu₂Sb
NiSb
ZnSb
MoSb
MnSb
InSb
AgSb
MgSb
Ti Sb
VSb
CrSb

Typical cathode materials are:
Lithium cobalt oxide (LiCoO₂; LCO)
Lithium nickel cobalt oxide (LiNi_{0.8}Co_{0.15}Al0.0₅O₂; NCA)
Lithium manganese oxide (LiMn₂O₄; LMO)
Lithium (excess) manganese oxide (Li₂MnO₃)
Doped lithium manganese oxide (LiMn₂₋ₓMₓO₄)
Lithium manganese nickel oxide (LiMn_{1.5}Ni_{0.5}O₄; LMNO)
Lithium manganese nickel cobalt oxide composite (Li₁₊ₓMnₓNi_{y}Co_{z}O₂)
Iron Phosphate (FePO₄; FP)
Aluminum phosphate (AlPO₄)
Lithium cobalt phosphate (LiCoPO₄)
Lithium iron phosphate (LiFePO₄; LFP)
Doped lithium cobalt phosphate (LiCo₁₋ₓMxPO₄; M: Mn, Fe, Co, V, Gd, Mg)
Ti-doped lithium manganese nickel oxide (LiMn₁₋ₓTiₓNi₅O₄; LTMNO)
Iron disulfide (FeS₂)
Titanium disulfide (TiS₂)
Sodium manganese oxide (Na_{0.44}MnO₂; Na₂Mn₅O₁₀)
Sodium manganese nickel oxide (NaMn₂₋ₓNiₓO₄)
Doped sodium manganese nickel oxide (NaNi_{0.33}FeₓMn_{0.333}Mg_{y}Sn_{z}O₂)
Sodium cobalt oxide (NaₓCoO₂)
Sodium iron manganese oxide (Naₓ[Fe_{0.5}Mn_{0.5}]O₂)
Sodium lithium nickel manganese oxide (Na_{0.85}Li_{0.17}Ni_{0.21}Mn_{0.64}O₂)
Sodium iron phosphate (NaFePO₄—Olivine)
Sodium cobalt mixed phosphates (Na₄Co₃(PO₄)₂P₂O₇)
Sodium cobalt manganese nickel mixed phosphates (Na₄Co_{2.4}Mn_{0.3}Ni_{0.3}(PO₄)₂P₂O₇)
Sodium iron mixed phosphates (Na₄Fe₃(PO₄)₂P₂O₇)
Sodium iron sulfate (NaFe(SO₄)₂; Eldfellite mineral)

The separator 14 preferably is porous so that ions may travel between the anode and cathode sheets. Often, the separator is usually saturated with a separator liquid for the ions to travel in. Solid electrolytes are also known.

An additional separator layer may be provided on top of the cathode material in order to prevent direct contact between the cathode material and another layer of this material or the anode material.

In FIG. 3, different manners of building a battery are illustrated. To the left, a flat structure is seen where the separator is shaped into a Z-shape (serpentine) with layers of anode and cathode alternately positioned on the separator layer, so that between an anode layer and a cathode layer, a layer of the separator is seen. The final shape is illustrated to the lower left.

At the centre of FIG. 3, a similar structure is achieved by not providing the separator on a roll but also as sheets.

To the right, lamination of sheets of the battery are seen as well as two manners of rolling the laminate. To the lower left of this embodiment, a standard cylindrical roll is seen. To the right, a so-called prismatic roll is seen which is rolled, such as over a linear or flat bobbin or element, with a more oblong or oval structure or shape.

Reverting to FIG. 1, a folding line A is illustrated. In preferred embodiments of the invention, the laminate is folded along an axis, such as A, before rolling. In this manner, the outer layer of the roll is of the anode material also at one end thereof. Clearly, the laminate may be folded multiple times, such as along multiple axes parallel to A.

The rolling then preferably is along a direction parallel to A—around an axis perpendicular to A.

In addition, it is seen in FIGS. 1 and 2 that the cathode material, in the view of FIG. 1, lays completely within the separator material and the anode material and that the separator lies within the anode material on 3 sides and extends further out opposite to the bending. Thus, when rolled, and even when not folded, the anode material will also be covering the separator and the cathode at one end. Actually, the end of the roll may be deformed (compressed) at one end such as when contacting an end portion of the battery casing without risking contact between the anode material and the cathode material. Then, contact to an end portion (see further below) may simply be obtained by simple biasing of the end of the roll toward that end portion.

In FIG. 10, the result of a bent laminate where the cathode 16 has been folded to obtain twice the thickness and where the separator is folded to generate a U-shaped lower portion. The anode 12 is also folded to become U-shaped at the bottom 141.

In FIG. 11, an alternative method is seen where the cathode layer is a single layer, the separator has been provided as two layers which are connected to form a V-shaped portion 142 and where the anode 12 is provided as two individual layers.

Common to these embodiments, which may also be mixed, is that the separator prevents any electrical contact between the anode and cathode at this lower end portion of the laminate. Thus, a number of manners of contacting the anode layer at this position lend themselves—such as by simply forcing the end of the laminate into an electrically conducting, resilient material also in contact with a terminal of the battery.

A serpentine folding would have the same functionality. This type of folding is interesting in relation to pouch batteries.

In this situation, when rolling the folded laminate, the anode layer will contact itself in the roll. The same may be the situation for the cathode layer in the folded laminate. This may be taken into account when deciding on the dimensions of the laminate.

The cathode layer may be made to have a smaller area, such as only the upper half in FIG. 2. Then, the folding is a folding of the separator and anode layer around the axis A and thus around the unfolded cathode layer.

Also, when the laminate has been folded as described, one end portion of the roll will also expose only the anode material. In that manner, casing of the laminate roll is extremely simple, in that all of the end portion and the outer portion along the casing sides will be anode material. Then, it may not even be necessary to provide an electrical insulation between the jelly roll and the battery casing and the anode end cap.

Actually, also the sides of the roll expose only the laminate, so this side of the laminate may be connected to the sides of the casing in the same manner if desired.

The cathode is accessible, such as via the tab 18, at the opposite end of the roll. Naturally, a tab may be provided as illustrated at 18′ which would extend out of the roll at the circumference thereof.

Multiple tabs may be provided for higher current transport capabilities and better thermal balance.

The tabs 18 may be made of any material, such as pyrolytic graphite sheets which have good mechanical properties in addition to very high electrical and thermal conductivity and a good resistance to corrosion. Such tabs may be gold plated to prevent corrosion thereof. Clearly, an insulation layer, such as a sol-gel, may be provided closer to the cathode material in order to prevent electrical contact to the anode layer.

FIG. 4 illustrates a preferred battery casing 20 type having a central volume 201 for receiving at least a portion of the rolled laminate as well as a shoulder portion 203 having an opening 205 for gaining electrical access to the laminate from outside of the casing. In an alternative embodiment, the shoulder portion 203 could be replaced by a complete closing of the casing, such as if the casing is connected to the anode of the laminate.

At the opposite end of the battery casing 20, an opening 207 is provided through which the rolled laminate may be introduced into the volume 201.

In FIG. 5, a battery assembly 30 is illustrated having the actual laminate roll 301, from which a number of tabs 18 extend which are connected to a cathode end portion 310. As the environment in a battery is rather corrosive, it may be preferred to provide a corrosion resistive coating, such as gold, on both the end portion 310 and the tabs 18. The tabs may be made of carbon fullerenes such as PGS which also has the advantage of providing and retaining a good resilience to maintain a good physical contact between the tab and the end cap.

The opposite (upper) end portion of the laminate preferably exposes only the anode layer, so that this portion may be simply biased toward an anode end portion 305. Optionally, a resilient, electrically conducting material, such as a gel, may be provided between the end portion 305 and the end of the roll 301. As will be described below, the end portion 305 is optional.

The tabs 18 may merely be biased toward the end portion 310, such as if made flexible and elastically deformable. Alternatively, the tabs may be welded, soldered or glued to the end portion 310.

The assembly 30 may be fully or partly assembled before introduction into the casing 20. Otherwise, the end portion 310 may simply be provided in the volume 201, where after the roll 301 may be provided therein and the end portion 305 provided before the casing is closed. Alternatively, the battery assembly of FIG. 5 may be rotated 180 degrees so that the “anode end” is introduced into the casing 20 first. Then, the upper closing (see below) may comprise an opening for access to the end portion 310 connected to the cathode layer.

The shoulder portion 203 prevents portion 310 from exiting the volume 201. The end portion 310 may seal toward the shoulder portion or other portions of the casing to provide an air tight seal.

Naturally, electrical insulation may be provided between the casing material and the end portion 310 which is connected to the cathode material.

The end portion 310 is exposed via the opening 205, so that electrical connection from the outside is possible.

The upper end, in the drawing, of the battery casing may be closed in a number of manners. The casing may be longer than the length of the end portion 310 and the roll 301, so that an upper portion of the casing may be deformed inwardly to close the volume or, if the end portion 305 is provided, seal toward the end portion 305. If the end portion 305 is not provided, the casing material may be deformed to completely seal the volume 21 at that end. The above contacting to the upper end of the roll 301 may be performed equally well to inwardly directing portions of the casing material.

In FIG. 4, inwardly bent portions are illustrated with hatched lines at two different positions.

In FIG. 4, the upper portions of the casing 20 are illustrated as flaring outwardly. This has the advantage that the assembly 30 may more easily be introduced into the volume 201. In addition to this, the inner surface of the casing may be coated with a material giving a smooth surface to further assist in the introduction of the assembly 30 into the volume 201.

A tight fit is desired, so that the roll preferably has an outer shape, such as a cross sectional shape in a direction perpendicular to the axis around which the roll was rolled, conforming to an inner shape of the casing 20.

A number of advantages may be made in relation to battery casings, such as that of FIG. 4. Firstly, many battery casings are made of deep drawn steel. Deep drawing, however, results in stress fractures which provide very rugged inner surfaces which require the addition of a protective layer to prevent damaging of the laminate roll during insertion. This layer takes up valuable space.

The battery casing 20 may instead be manufactured from a rod shaped material which may be deformed or worked to provide the shoulder portion 203 and, if desired, the flaring portion 207. Rod shaped materials may have a smoother inner surface, as they may have stress fractures only at the shoulder portions and the flaring portion (if provided) so that no or only a thin layer of a protective material needs be provided in the volume 201.

A weight saving may be obtained if, instead of steel, a lighter material is used, such as magnesium, beryllium, titanium, aluminium, or alloys comprising such materials, such as AZ31, lithium, silicon or the like. The material may be enforced such as by fibres or microspheres. Desired properties are compressive strength, tensile strength, heat conduction and resistance to corrosion.

Clearly, if the casing is made of a material which would react with a material of the laminate, such as the anode material, due to ion transport between these, a coating may be provided in the casing to prevent this. This coating may be electrically insulating but need not be thick.

A suitable coating type is a sol-gel which may be both electrically insulating may provide a smooth surface and be very thin. Sol-gels may be applied by spraying, coating, spin coating, dip coating or the like.

A large number of cheap and useful sol-gels are available. Interesting properties are a high dielectric constant, low weight, effective even as a thin layer, impermeable to electrolyte and ions, resistant to battery chemistry, high heat conductance etc.

Other coating types may be coatings with metals, such as nickel or gold, or polymers of any type. The coating may have multiple layers. For example, it may be desired to provide an initial gold plating in order for a later coating, such as a sol-gel, to be sufficiently attached. Internal metal plating has the advantage that electrical connection between the anode layer and the casing is automatic.

A coating may be provided on both the inner and outer side of the casing material. An outer coating may be desirable e.g. in situations where the casing material is of a corrosion/oxidation prone material, such as magnesium or aluminium.

Clearly, even though the above embodiments have been described with the anode material being the largest and the outer-most material. The laminate may be inverted so that the cathode layer is the outermost layer if desired.

Batteries typically comprise a safety switching mechanism, often called a Current Interruption Device (CID), which is intended to prevent further current delivery, when the laminate overheats and/or if a pressure therein becomes excessive.

A new CID is illustrated in FIG. 6 in which it is provided in the end portion 310. The end portion 310 has, seen from the outside, a convex shape with an element for positioning in the opening 205. This element forms a convex conductor for engagement from the outside of the battery. The inner concavity is utilized to provide a shallower CID.

The CID has, in the direction of the drawing, an upper contact element 311 for contacting the outer, convex conductor 312 of the end portion 310. The contact element 311 is connected to an inner conducting element 313 which, at its lower surface, is connected to the laminate roll. In the inner conducting element 313, a cavity 314 exists into which the contact element 311 may move, if temperature sensitive controlling elements 315 experience a sufficiently high temperature.

Electrical connection may be provided from the inner conducting element 313 to the conducting element 311 via the temperature sensitive controlling elements 315. Alternatively, another element may be provided for ensuring this contact.

The temperature sensitive controlling element ensures contact between the contact element and the convex conductor during normal operation but is/are configured to move, such as translate and/or rotate, the upper element 311 into the cavity 314, when the temperature exceeds a threshold temperature. Then, the contact between the contact element and the convex conductor is broken and current delivery from the laminate prevented.

The temperature sensitive controlling element may be any type of material configured to change shape with temperature, such as memory materials or bimetallic actuators.

Preferably, the threshold temperature is higher than 50 degrees Celsius, such as higher than 60, 70, 80, 90 or 100 degrees or even higher than 110, 120, 130 or 140 degrees. On the other hand, the threshold temperature preferably is below 180 degrees, such as below 160, 150 or 140 degrees, such as below 130 degrees Celsius, such as below 120 degrees, 110 degrees or 100 degrees.

Naturally, CIDs of this type may be implemented anywhere in a battery, but the present embodiment is preferred at the positive terminal of circular batteries, as they usually have a convex portion, as a part of the cathode terminal, inside which the CID may be positioned so as to take up as little space as possible within the main volume of the battery casing.

Batteries also usually comprise an over pressure valve allowing gasses to escape the casing interior. Often such valves are irreversible in the sense that they are formed as weak gaskets which break along which a controlled breaking and thus venting takes place, if the internal pressure in the battery exceeds a pressure threshold.

A new type of vent is seen in FIG. 7, where a vent 400 is formed over a portion of the battery casing. In the present example, a vent 400 is formed in the end cap 310, but may in principle be positioned anywhere in a battery casing.

The vent 400 comprises a vent channel 410 with one opening 412 to the surroundings of the battery and an opening 414 toward the inner volume 201 of the battery casing.

The vent channel may have any desired length and width and extends in a plane inside the portion, here the end cap, of the casing. When the channel 410 extends along a plane of the casing portion, it may be much longer than a width or thickness of the casing material. In this context, the plane may be straight or bent. The channel may be selected to be serpentine or very meandering in order to define the gas flow therein. When the end cap is a plane element, the plane in which vent channel extends, may be plane. If, on the other hand, the vent 400 is provided in a curved portion of a battery, such as on a side of a cylinder shaped casing, the vent channel may extend inside the wall and along the curvature of the wall portion. A straight vent may be obtained if extending along a longitudinal direction of the cylinder.

Even when the vent channel 410 is open, gas transport over it may be prevented or at least sufficiently low, if the channel is sufficiently long, sufficiently narrow and/or sufficiently meandering. The channel need not have the same width along its length, so also narrowed portions will act to prevent gas transfer. This is at least the situation when the pressure difference over the channel is sufficiently low. At higher pressure differences, the channel should allow a predetermined gas flow to allow the pressure difference to reduce or at least not grow.

Another manner of preventing gas flow at low pressure differences is to provide a material 416 in the channel. A sufficiently high pressure difference may force the material 416 out of the channel 410 to allow gas transport.

One manner of providing a channel with a material therein may, c.f. FIG. 8, be obtained by providing the casing portion, such as the end cap, as a multiple of layers. Then, a lower layer with the opening 414 may be formed on which the material 416 is positioned. After that, a top layer may be provided and the opening 412 therein. The material 416 then may form the channel as it prevents the material of the top layer from occupying the space reserved by the material.

The material may be a polymer, a wax or the like.

Naturally, the material may be removed by a sufficiently high pressure difference, but the material preferably is softened, such as melted or evaporated, at a predetermined elevated temperature, such as a temperature above 130, 140 or 120 degrees Celcius, such as above 80 degrees. An increased temperature results in an increased pressure and thus requires the opening of the channel.

Subsequently, the channel may remain open, which may not be preferred.

A solution may be seen in FIG. 9, where a reservoir 420 is connected to the channel 410. Then, when an overpressure forces the material 416 also into the reservoir 420, where the material may remain until the pressure in the channel 410 drops, where after the material may again travel into the channel 410 to again prevent gas transport through the channel 410. Not all of the material may travel into the reservoir, but enough to re-close the channel 410 would suffice. Clearly, the amount of material and the size and position of the reservoir may be adapted so that the channel may be re-closed a single time or multiple times.

When forced into the reservoir, an overpressure will be created therein which will act to force the material out of the reservoir, when the pressure in the channel drops.

The material, as mentioned above, may be softened due to a temperature increase. In that manner, when the pressure difference decreases and the temperature drops, the material forced back onto the channel may liquefy/solidify and thereby effectively seal the channel again.

The size of the reservoir may be adapted to the amount of material in the channel or at least to an amount required to re-close the channel. Additional material initially in the channel may be expelled from the channel due to the pressure increase and gas flow.

The reservoir may be positioned closer to the opening 414 toward the interior of the casing, as the remainder of the channel (the portion of the channel between the opening to the reservoir and the opening 412) may act to provide a counter pressure keeping the absolute pressure in the reservoir rather high. Then, when the pressure drop decreases, the material will be re-introduced into the channel with this counter pressure assisting in maintaining the material in the channel instead of expelling the material from the channel. Also, when a length of the channel exists between the opening toward the reservoir and the opening 412, the material forced out of the reservoir will be able to settle in the channel instead of being forced out of the opening 412.

Clearly, multiple reservoirs may be provided if desired.

The reservoir may initially be empty (except for a gas) in order for it to be able to receive the material. The pressure in the reservoir will increase, whereby the material will compress the gas to occupy a part of the reservoir. When the temperature and the pressure in the channel decreases, the compressed gas in the reservoir will force the material back into the channel.

Alternatively, the reservoir may be pre-filled with material.

In the above embodiments, a number of technologies are presented which may be combined into a single battery with much higher energy density and better performance than other, known batteries.

However, the technologies may also be used individually. For example, a folded and rolled laminate may be used in already known battery casings, as may the CID and the vent channel.

The above battery casing may be used for standard laminate rolls and standard end portions if desired.

Also, the CID and vent channel may be employed in other types of batteries, such as pouch batteries which may also or alternatively receive a folded, rolled laminate with prismatic shape.

### EMBODIMENTS

1. A battery comprising a casing and a charge holding laminate, wherein:

the casing has a first and a second electrical terminal and
the laminate provided in the casing, the laminate comprises at least three layers:
a cathode layer
an anode layer and
a separator provided between the cathode layer and the anode layer,
wherein, in a cross section of the laminate:
the separator forms a U- or V-shaped structure inside which the cathode layer is provided and
the anode layer is provided on both sides of the separator and extend farther in the direction of the bottom of the U- or V-shaped structure than the separator and
wherein the cathode layer is connected to the first electrical terminal of the casing and the anode layer is connected to the second electrical terminal of the casing.

2A. A battery according to embodiment 1, wherein at least the separator is folded or bent along a first axis and wherein the laminate is folded or bent along or around a second axis which is non-parallel to the first axis.

2. A battery according to embodiment 1 or 2A, wherein the laminate is formed as a coil of a folded laminate.

3. A battery according to embodiment 2A or 2, wherein the anode layer is outside of the separator and the cathode layer.

4. A battery according to embodiment 2A, 2 or 3, wherein the laminate is folded by folding the separator and anode layers around the cathode layer.

5. A battery according to any of the preceding embodiments, wherein the casing has a central portion having a cavity or channel with a longitudinal axis and a predetermined cross sectional area in a plane perpendicular to the axis and further comprises:

an opening at one end thereof and
a cap portion blocking the opening and forming the first or the second electrical terminal.

6. A battery according to embodiment 5, wherein an opposite end portion of the casing forms the other of the first and the second terminal.

7. A battery according to embodiment 6, wherein an electrically conducting, resilient material is provided between the other of the cathode layer and the anode layer and the opposite end portion of the casing.

8. A battery according to any of the preceding embodiments, further comprising one or more tab portions extending from at least one of the cathode layer and the anode layer.

9. A battery according to any of the preceding embodiments, further comprising a wall part and a vent element formed in the wall part, the vent element comprising a channel having a first opening and a second opening, the first opening opening into the cavity, the second opening opening toward surroundings of the battery and at least a portion of a length of the channel extending at least substantially in a plane of the wall part.

10. A battery according to any of the preceding embodiments, further comprising:

a concave end cap, the casing having an opening closed by the end cap, the end cap having a cavity facing an inner space of the casing, and
a thermal switch comprising:
a connection portion electrically connected to one of the anode layer and the cathode layer and being configured to move between a first position and a second position, where, in the first position, the connection portion is electrically connected to the end cap within the cavity, and in the second position, the connection portion is at a at least a predetermined distance from the end cap so as to not be electrically connected to the end cap, and
a thermally reactive element configured to position the end connection portion in the first position when the temperature is below a threshold temperature and in the second position when the temperature is above the threshold temperature.

11. A battery according to any of the preceding embodiments, wherein the casing has:

a central portion having a cavity or channel with a longitudinal axis and a predetermined cross sectional area in a plane perpendicular to the axis,
a first end portion adjacent to the central portion, the first end portion forming an inwardly extending shoulder,
a second end portion adjacent to the central portion oppositely to the first end portion, the second end portion comprising an opening into the cavity/channel, and
an electrically conducting cap portion in the cavity/channel and adjacent to the shoulder portion.

12. A method of manufacturing a battery, the method comprising:
1. providing a charge holding laminate comprising at least an anode layer, a cathode layer and a separator layer provided between the anode layer and the cathode layer, wherein, in a cross section of the laminate:
   the separator forms a U- or V-shaped structure inside which the cathode layer is provided and
   the anode layer is provided on both sides of the separator and extend farther in the direction of the bottom of the U- or V-shaped structure than the separator and
2. folding or bending the,
3. providing the folded/bent laminate in a casing having a first and a second electrical terminal,
4. connecting the cathode layer to the first electrical terminal of the casing and the anode layer to the second electrical terminal of the casing.

14. A method according to embodiment 13, wherein the first and/or folding provides the anode layer outside of the separator and the cathode layer.

15. A method according to any of embodiments 12-14, wherein step 3 comprises:
providing the folded/bent laminate in a casing having a central portion having a cavity or channel with a longitudinal axis and a predetermined cross sectional area in a plane perpendicular to the axis and
providing the folded/bent laminate into the cavity/channel through an opening at one end thereof and
   the method further comprising the step of blocking the opening with a cap portion forming the first electrical terminal.

16. A method according to embodiment 15, wherein the cap portion forms one of the first and second terminal.

17. A method according to embodiment 16, wherein an opposite end portion of the casing forms the other of the first and second terminal.

18. A method according to embodiment 17, further comprising providing an electrically, resilient material between the other of the cathode layer and the anode layer and the opposite end portion of the casing.

19. A method according to any of embodiments 12-18, further comprising the step of providing one or more tab portions extending from at least one of the cathode layer and the anode layer.

20. A method according to any of embodiments 12-19, wherein step 4 comprises providing a casing comprising an inner channel or cavity closed at one end by an electrically conducting cap portion electrically connected to a layer of the laminate and a casing portion,

wherein the step of providing the casing portion comprises:
providing a first portion part with a first opening, the first opening opening into the cavity,
providing a first material on the first portion part, the first material extending from the first opening,
providing a second material on the first portion part and the first material and with a second opening at the first material, the second opening opening toward the surroundings of the battery.

21. A method according to any of embodiments 12-20, further comprising the step of venting gas from an inner cavity of a battery, the method comprising venting the gas to surroundings of the battery via a vent element formed in a wall part of the battery, the vent element comprising a channel having a first opening and a second opening, the first opening opening into the cavity, the second opening opening toward the surroundings of the battery and at least a portion of a length of the channel extending at least substantially in a plane of the wall part.

22. A method of switching of a battery according to any of embodiments 1-11 when overheating, the method comprising:

providing the battery with:
a concave end cap,
a casing having an opening closed by the end cap, the end cap having a cavity facing an inner space of the casing, and
a thermal switch comprising a connection portion, in electrical contact with one of the anode layer and the cathode layer, and a thermally reactive element configured to move the connection portion,
   the method comprising:
when the temperature is below a threshold temperature, the thermally reactive element positions the connection portion in a first position in electrical contact with the end cap in the cavity thereof and
when the temperature is above the threshold temperature, the thermally reactive element positions the connection portion in a second position in which it has at least a predetermined minimum distance to the end cap so as to not be electrically connected to the end cap,

23. A method according to any of embodiments 12-23, the method comprising:

providing the casing having:
a central portion having a cavity or channel with a longitudinal axis and a predetermined cross sectional area in a plane perpendicular to the axis,
a first end portion adjacent to the central portion, the first end portion forming an inwardly extending shoulder,
a second end portion adjacent to the central portion oppositely to the first end portion, the second end portion comprising an opening into the cavity/channel,
   positioning an electrically conducting cap portion in the cavity/channel and adjacent to the shoulder portion,
   providing the charge holding laminate in the cavity/channel,
   electrically connecting one of the anode layer and the cathode layer of the laminate to the cap portion,
   closing the second end portion of the casing and electrically connecting the other of the anode layer and the cathode layer to an electrical terminal of the casing.

24. A method of assembling a battery comprising a charge holding laminate and a casing, the method comprising:

providing the casing having:
a central portion having a cavity or channel with a longitudinal axis and a predetermined cross sectional area in a plane perpendicular to the axis,
a first end portion adjacent to the central portion, the first end portion forming an inwardly extending shoulder,
a second end portion adjacent to the central portion oppositely to the first end portion, the second end portion comprising an opening into the cavity/channel,
   positioning an electrically conducting cap portion in the cavity/channel and adjacent to the shoulder portion,
   providing a charge holding laminate in the cavity/channel, the charge holding laminate comprising at least an anode layer, a cathode layer and a separator layer provided between the anode layer and the cathode layer,
   electrically connecting one of the anode layer and the cathode layer of the laminate to the cap portion,
   closing the second end portion of the casing and electrically connecting the other of the anode layer and the cathode layer to an electrical terminal of the casing.

25. A method according to embodiment 24, wherein the closing step comprises deforming the second end portion.

26. A method according to embodiment 24 or 25, wherein the step of providing the casing comprises providing a casing having a funnel-shaped second portion.

27. A method according to any of embodiments 24-26, wherein the step of providing the casing comprises providing a casing of magnesium, beryllium, titanium, aluminium, or alloys comprising such materials, such as AZ31, or lithium, silicon or the like and covering an inner surface thereof with a sol-gel.

28. A method according to embodiment 27, wherein the step of providing the casing further comprises providing the casing with an outer, oxidation preventing layer.

28A. A method according to any of embodiments 24-28, where the method of providing the casing comprises cutting a tube-shaped element into a plurality of casing preforms and subsequently machining each casing preform to form casings therefrom.

29. A method according to any of embodiments 24-28 and 28A, wherein the step of providing the charge-holding laminate comprises proving a charge holding laminate having one or more tab portions extending from at least one of the anode layer and the cathode layer, and wherein the step of electrically connecting the one layer to the cap portion comprises providing electrical contact between one or more of the tabs and the cap portion.

30. A method according to any of embodiments 24-29, further comprising the step of electrically connecting the other of the anode layer and the cathode layer to an electrical terminal of the casing.

31. A method according to embodiment 30, wherein the electrical terminal of the casing is an end portion of the casing at the second end thereof, and wherein the step of electrically connecting the other of the anode layer and the cathode layer to the electrical terminal comprises providing an electrically conductive and resilient material between the other layer and the end portion.

32. A method according to any of embodiments 24-31, wherein the step of providing the charge holding laminate comprises:
1. providing a charge holding laminate comprising at least an anode layer, a cathode layer and a separator layer provided between the anode layer and the cathode layer,
2. firstly folding or bending the laminate along or around a first axis, and
3. Subsequently folding or bending the laminate along or around a second axis not parallel to the first axis.

33. A method according to any of embodiments 24-32, the wherein the step of providing the casing portion or end cap comprises:

providing a first portion part with a first opening, the first opening opening into the cavity,
providing a first material on the first portion part, the first material extending from the first opening,
providing a second material on the first portion part and the first material and with a second opening at the first material, the second opening opening toward the surroundings of the battery.

34. A method of venting gas from an inner cavity of a battery assembled by the method of any of embodiments 24-33, the method comprising venting the gas to surroundings of the battery via a vent element formed in a wall part of the battery, the vent element comprising a channel having a first opening and a second opening, the first opening opening into the cavity, the second opening opening toward the surroundings of the battery and at least a portion of a length of the channel extending at least substantially in a plane of the wall part.

35. A method of switching of a battery, assembled by the method of any of embodiments 24-33, when overheating, wherein the end cap is concave, the method comprising:
when the temperature is below a threshold temperature, the thermally reactive element positions the connection portion in a first position in electrical contact with the end cap in the cavity thereof and
when the temperature is above the threshold temperature, the thermally reactive element positions the connection portion in a second position in which it has at least a predetermined minimum distance to the end cap so as to not be electrically connected to the end cap.

36. A casing for use in the method of any of embodiments 24-35, the casing having:
a central portion having a cavity or channel with a longitudinal axis and a predetermined cross sectional area in a plane perpendicular to the axis,
a first end portion adjacent to the central portion, the first end portion forming an inwardly extending shoulder,
a second end portion adjacent to the central portion oppositely to the first end portion, the second end portion comprising an opening into the cavity/channel, and
an electrically conducting cap portion in the cavity/channel and adjacent to the shoulder portion.

37. A casing according to embodiment 36, wherein the casing has a funnel-shaped second portion.

38. A casing according to any of embodiments 36 and 37, the casing being of magnesium, magnesium, beryllium, titanium, aluminium, or alloys comprising such materials, such as AZ31, or lithium, silicon or the like, the inner surface of of the casing being covered with a sol-gel.

39. A casing according to embodiment 38, further comprising an outer, oxidation preventing layer.

40. The casing according to any of embodiments 36-38, the casing further comprising a charge holding laminate positioned in the cavity/channel, the charge holding laminate comprising at least an anode layer, a cathode layer and a separator layer provided between the anode layer and the cathode layer, wherein one of the anode layer and the cathode layer of the laminate is electrically connected to the cap portion.

41. The casing according to embodiment 40, wherein the charge holding laminate has one or more tab portions extending from at least one of the anode layer and the cathode layer and being in electrical contact with the cap portion.

42. A battery comprising the casing according to any of embodiments 36-41, the battery further comprising a charge holding laminate provided in the casing.

43. A battery provided by the method according to any of embodiments 24-33, the battery comprising:

a casing having:
a central portion having a cavity or channel with a longitudinal axis and a predetermined cross sectional area in a plane perpendicular to the axis,
a first end portion adjacent to the central portion, the first end portion forming an inwardly extending shoulder,
a second end portion adjacent to the central portion oppositely to the first end portion, the second end portion comprising an opening into the cavity/channel,
   an electrically conducting cap portion in the cavity/channel and adjacent to the shoulder portion, and
   a charge holding laminate in the cavity/channel, the charge holding laminate comprising at least an anode layer, a cathode layer and a separator layer provided between the anode layer and the cathode layer,
   where one of the anode layer and the cathode layer of the laminate is electrically connected to the cap portion, and
   the second end portion of the casing is closed by a second end cap electrically connected to the other of the anode layer and the cathode layer.

44. A battery according to embodiment 42, further comprising an electrically conductive and resilient material electrically connecting the second end cap to the other layer.

45. A battery according to any of embodiments 42-44, wherein the casing has a first and a second electrical terminal, the laminate is folded or bent along or around at least two non-parallel axes and is provided in the casing and wherein cathode layer is connected to the first electrical terminal of the casing and the anode layer is connected to the second electrical terminal of the casing.

46. A battery according to any of embodiments 42-45, the casing comprising an inner cavity closed at one end by an electrically conducting cap portion electrically connected to a layer of the laminate, the battery further comprising a wall part and a vent element formed in the wall part, the vent element comprising a channel having a first opening and a second opening, the first opening opening into the cavity, the second opening opening toward surroundings of the battery and at least a portion of a length of the channel extending at least substantially in a plane of the wall part.

47. A battery according to any of embodiments 42-46, comprising:

a concave end cap,
a casing having an opening closed by the end cap, the end cap having a cavity facing an inner space of the casing, and
a thermal switch comprising:
a connection portion electrically connected to one of the anode layer and the cathode layer and being configured to move between a first position and a second position, where, in the first position, the connection portion is electrically connected to the end cap within the cavity, and in the second position, the connection portion is at a at least a predetermined distance from the end cap so as to not be electrically connected to the end cap, and
a thermally reactive element configured to position the end connection portion in the first position when the temperature is below a threshold temperature and in the second position when the temperature is above the threshold temperature.

48. A battery with a casing and a charge holding laminate provided in an inner cavity closed at one end by an electrically conducting cap portion electrically connected to a layer of the laminate,

the battery further comprising a wall part and a vent element formed in the wall part, the vent element comprising a channel having a first opening and a second opening, the first opening opening into the cavity, the second opening opening toward surroundings of the battery and at least a portion of a length of the channel extending at least substantially in a plane of the wall part.

49. A battery according to embodiment 48, further comprising a solid, gel or liquid material with a predetermined melting or evaporation temperature in the interval of 85-120° C., the material being positioned in the channel.

50. A battery according to embodiment 48 or 49, further comprising one or more reservoirs provided in the wall part, each reservoir having a single opening, each single opening opening into the channel.

51. A battery according to any of embodiments 48-50, wherein:
the casing has a first and a second electrical terminal and
the laminate comprises at least three layers:
a cathode layer
an anode layer and
a separator provided between the cathode layer and the anode layer,
   wherein the laminate is folded or bent along or around at least two non-parallel axes (first around one axis and then the folded/bent laminated is further folded/bent along another axis) and is provided in the casing and
   wherein cathode layer is connected to the first electrical terminal of the casing and the anode layer is connected to the second electrical terminal of the casing.

52. A battery according to any of embodiments 48-51, the casing having:
a central portion having a cavity or channel with a longitudinal axis and a predetermined cross sectional area in a plane perpendicular to the axis,
a first end portion adjacent to the central portion, the first end portion forming an inwardly extending shoulder,
a second end portion adjacent to the central portion oppositely to the first end portion, the second end portion comprising an opening into the cavity/channel, and
an electrically conducting cap portion in the cavity/channel and adjacent to the shoulder portion.

53. A battery according to any of embodiments 48-52, the battery comprising:

a concave end cap, the casing having an opening closed by the end cap, the end cap having a cavity facing an inner space of the casing,
a charge holding laminate in the casing, the charge holding laminate comprising at least an anode layer, a cathode layer and a separator layer provided between the anode layer and the cathode layer, and
a thermal switch comprising:
a connection portion electrically connected to one of the anode layer and the cathode layer and being configured to move between a first position and a second position, where, in the first position, the connection portion is electrically connected to the end cap within the cavity, and in the second position, the connection portion is at a at least a predetermined distance from the end cap so as to not be electrically connected to the end cap, and
a thermally reactive element configured to position the end connection portion in the first position when the temperature is below a threshold temperature and in the second position when the temperature is above the threshold temperature.

54. A method of producing a battery according to any of embodiments 48-53, the method comprising providing a casing comprising an inner channel or cavity closed at one end by an electrically conducting cap portion electrically connected to a layer of the laminate and a casing portion,

wherein the step of providing the casing portion comprises:
providing a first portion part with a first opening, the first opening opening into the cavity,
providing a first material on the first portion part, the first material extending from the first opening,
providing a second material on the first portion part and the first material and with a second opening at the first material, the second opening opening toward the surroundings of the battery.

55. A method of venting gas from an inner cavity of a battery, the method comprising venting the gas to surroundings of the battery via a vent element formed in a wall part of the battery, the vent element comprising a channel having a first opening and a second opening, the first opening opening into the cavity, the second opening opening toward the surroundings of the battery and at least a portion of a length of the channel extending at least substantially in a plane of the wall part.

56. A method according to embodiment 55, wherein the battery further comprises a solid, gel or liquid material with a predetermined melting or evaporation temperature in the interval of 85-120° C., the material being positioned in the channel, the method comprising the step of heating the material to above 85 degrees.

57. A method according to embodiments 56, wherein the battery further comprises one or more reservoirs provided in the wall part, each reservoir having a single opening, each single opening opening into the channel, and wherein the method comprises displacing material into at least one of the reservoirs during venting.

58. A method according to any of embodiments 54-57, the method comprising:
1. providing a charge holding laminate comprising at least an anode layer, a cathode layer and a separator layer provided between the anode layer and the cathode layer,
2. firstly folding or bending the laminate along or around a first axis,
3. Subsequently folding or bending the laminate along or around a second axis not parallel to the first axis,
4. providing the folded/bent laminate in a casing having a first and a second electrical terminal,
5. connecting the cathode layer to the first electrical terminal of the casing and the anode layer to the second electrical terminal of the casing.

59. A method according to any of embodiments 54-58, the method comprising:

providing the casing having:
a central portion having a cavity or channel with a longitudinal axis and a predetermined cross sectional area in a plane perpendicular to the axis,
a first end portion adjacent to the central portion, the first end portion forming an inwardly extending shoulder,
a second end portion adjacent to the central portion oppositely to the first end portion, the second end portion comprising an opening into the cavity/channel,
   positioning an electrically conducting cap portion in the cavity/channel and adjacent to the shoulder portion,
   providing a charge holding laminate in the cavity/channel, the charge holding laminate comprising at least an anode layer, a cathode layer and a separator layer provided between the anode layer and the cathode layer,
   electrically connecting one of the anode layer and the cathode layer of the laminate to the cap portion,
   closing the second end portion of the casing and electrically connecting the other of the anode layer and the cathode layer to an electrical terminal of the casing.

60. A method of switching of a battery according to any of embodiments 48-53, when overheating, the method comprising:

providing the battery comprising:
the end cap being a concave end cap,
the casing having an opening closed by the end cap, the end cap having a cavity facing an inner space of the casing,
a charge holding laminate in the casing, the charge holding laminate comprising at least an anode layer, a cathode layer and a separator layer provided between the anode layer and the cathode layer, and
a thermal switch comprising a connection portion, in electrical contact with one of the anode layer and the cathode layer, and a thermally reactive element configured to move the connection portion,
   the method comprising:
when the temperature is below a threshold temperature, the thermally reactive element positions the connection portion in a first position in electrical contact with the end cap in the cavity thereof and
when the temperature is above the threshold temperature, the thermally reactive element positions the connection portion in a second position in which it has at least a predetermined minimum distance to the end cap so as to not be electrically connected to the end cap.

61. A battery comprising:

a concave end cap,
a casing having an opening closed by the end cap, the end cap having a cavity facing an inner space of the casing,
a charge holding laminate in the casing, the charge holding laminate comprising at least an anode layer, a cathode layer and a separator layer provided between the anode layer and the cathode layer, and
a thermal switch comprising:
a connection portion electrically connected to one of the anode layer and the cathode layer and being configured to move between a first position and a second position, where, in the first position, the connection portion is electrically connected to the end cap within the cavity, and in the second position, the connection portion is at a at least a predetermined distance from the end cap so as to not be electrically connected to the end cap, and
a thermally reactive element configured to position the end connection portion in the first position when the temperature is below a threshold temperature and in the second position when the temperature is above the threshold temperature.

62. A battery according to embodiment 61, wherein the connection portion in the second position is closer to the laminate than in the first position.

63. A battery according to embodiment 61 or 62, wherein the thermally reactive element is attached in relation to the casing at a position between the end cap and the laminate.

64. A battery according to any of embodiments 61-63, wherein the thermally reactive element is configured to move the connection portion from the first position to the second position and back to the first position.

65. A battery according to any of embodiments 61-64, wherein the laminate is folded or bent along or around at least two non-parallel axes and is provided in the casing and wherein cathode layer or the anode layer is connected to the end cap.

66. A battery according to any of embodiments 61-65, wherein the casing has:
a central portion having a cavity or channel with a longitudinal axis and a predetermined cross sectional area in a plane perpendicular to the axis,
a first end portion adjacent to the central portion, the first end portion forming an inwardly extending shoulder,
a second end portion adjacent to the central portion oppositely to the first end portion, the second end portion comprising an opening into the cavity/channel, and
an electrically conducting cap portion in the cavity/channel and adjacent to the shoulder portion.

67. A battery according to any of embodiments 61-66, the casing comprising an inner cavity closed at one end by an electrically conducting cap portion electrically connected to a layer of the laminate,

the battery further comprising a wall part and a vent element formed in the wall part, the vent element comprising a channel having a first opening and a second opening, the first opening opening into the cavity, the second opening opening toward surroundings of the battery and at least a portion of a length of the channel extending at least substantially in a plane of the wall part.

68. A method of switching of a battery when overheating, the method comprising: providing a battery comprising:
a concave end cap,
a casing having an opening closed by the end cap, the end cap having a cavity facing an inner space of the casing,
a charge holding laminate in the casing, the charge holding laminate comprising at least an anode layer, a cathode layer and a separator layer provided between the anode layer and the cathode layer, and
a thermal switch comprising a connection portion, in electrical contact with one of the anode layer and the cathode layer, and a thermally reactive element configured to move the connection portion,
   the method comprising:
when the temperature is below a threshold temperature, the thermally reactive element positions the connection portion in a first position in electrical contact with the end cap in the cavity thereof and
when the temperature is above the threshold temperature, the thermally reactive element positions the connection portion in a second position in which it has at least a predetermined minimum distance to the end cap so as to not be electrically connected to the end cap.

69. A method according to embodiment 68, further comprising the step of the themally reactive element being heated and moving the connection portion from the first position to the second position.

70. A method according to embodiment 69, comprising the subsequent step of the thermally reactive element being cooled and moving the connection portion from the second position to the first position.

71. A method according to any of embodiments 68-70, wherein the step of providing the charge holding layer comprises the steps of:
1. firstly folding or bending the laminate along or around a first axis,
2. Subsequently folding or bending the laminate along or around a second axis not parallel to the first axis,
3. providing the folded/bent laminate in a casing having a first and a second electrical terminal, and
4. connecting the cathode layer to the first electrical terminal of the casing and the anode layer to the second electrical terminal of the casing.

72. A method according to any of embodiments 68-71, wherein the step of providing the casing comprises:

providing the casing having:
a central portion having a cavity or channel with a longitudinal axis and a predetermined cross sectional area in a plane perpendicular to the axis,
a first end portion adjacent to the central portion, the first end portion forming an inwardly extending shoulder,
a second end portion adjacent to the central portion oppositely to the first end portion, the second end portion comprising an opening into the cavity/channel,
   positioning an electrically conducting cap portion in the cavity/channel and adjacent to the shoulder portion,
   providing a charge holding laminate in the cavity/channel, the charge holding laminate comprising at least an anode layer, a cathode layer and a separator layer provided between the anode layer and the cathode layer,
   electrically connecting one of the anode layer and the cathode layer of the laminate to the cap portion,
   closing the second end portion of the casing and electrically connecting the other of the anode layer and the cathode layer to an electrical terminal of the casing.

73. The method according to any of embodiments 68-72, wherein the step of providing the casing comprises providing a casing comprising an inner channel or cavity closed at one end by an electrically conducting cap portion electrically connected to a layer of the laminate and a casing portion,

wherein the step of providing the casing portion comprises:
providing a first portion part with a first opening, the first opening opening into the cavity,
providing a first material on the first portion part, the first material extending from the first opening,
providing a second material on the first portion part and the first material and with a second opening at the first material, the second opening opening toward the surroundings of the battery.
   74. A method of venting gas from an inner cavity of a battery according to any of embodiments 61-67, the method comprising venting the gas to surroundings of the battery via a vent element formed in a wall part of the battery, the vent element comprising a channel having a first opening and a second opening, the first opening opening into the cavity, the second opening opening toward the surroundings of the battery and at least a portion of a length of the channel extending at least substantially in a plane of the wall part.

1.-13. (canceled)

14. A battery comprising a casing and a charge holding laminate, wherein:
the casing has a first and a second electrical terminal and
the laminate provided in the casing, the laminate comprises at least three layers:
a cathode layer,
an anode layer and
a separator provided between the cathode layer and the anode layer,
wherein, in a cross section of the laminate:
the separator forms a U- or V-shaped structure inside which the cathode layer is provided and
the anode layer is provided on both sides of the separator and extend farther in the direction of the bottom of the U- or V-shaped structure than the separator and
wherein the cathode layer is connected to the first electrical terminal of the casing and the anode layer is connected to the second electrical terminal of the casing.

15. The battery according to claim 14, wherein at least the separator is folded or bent along a first axis and
wherein the laminate is folded or bent along or around a second axis which is non-parallel to the first axis.

16. The battery according to claim 14, wherein the laminate is formed as a coil of a folded laminate.

17. The battery according to claim 15, wherein the anode layer is outside of the separator and the cathode layer.

18. The battery according to claim 15, wherein the laminate is folded by folding the separator and anode layers around the cathode layer.

19. The battery according to claim 14, wherein the casing has a central portion having a cavity or channel with a longitudinal axis and a predetermined cross-sectional area in a plane perpendicular to the axis and further comprises:
an opening at one end thereof and
a cap portion blocking the opening and forming the first or the second electrical terminal.

20. The battery according to claim 19, wherein an opposite end portion of the casing forms the other of the first and the second terminal.

21. The battery according to claim 20, wherein an electrically conducting, resilient material is provided between the other of the cathode layer and the anode layer and the opposite end portion of the casing.

22. The battery according to claim 14, further comprising one or more tab portions extending from at least one of the cathode layer and the anode layer.

23. The battery according to claim 14, further comprising a wall part and a vent element formed in the wall part, the vent element comprising a channel having a first opening and a second opening, the first opening opening into the cavity, the second opening opening toward surroundings of the battery and at least a portion of a length of the channel extending at least substantially in a plane of the wall part.

24. The battery according to claim 14, further comprising:
a concave end cap, the casing having an opening closed by the end cap, the end cap having a cavity facing an inner space of the casing, and
a thermal switch comprising:
a connection portion electrically connected to one of the anode layer and the cathode layer and being configured to move between a first position and a second position, where, in the first position, the connection portion is electrically connected to the end cap within the cavity, and in the second position, the connection portion is at a at least a predetermined distance from the end cap so as to not be electrically connected to the end cap, and
a thermally reactive element configured to position the end connection portion in the first position when the temperature is below a threshold temperature and in the second position when the temperature is above the threshold temperature.

25. The battery according to claim 14, wherein the casing has:
a central portion having a cavity or channel with a longitudinal axis and a predetermined cross-sectional area in a plane perpendicular to the axis,
a first end portion adjacent to the central portion, the first end portion forming an inwardly extending shoulder,
a second end portion adjacent to the central portion oppositely to the first end portion, the second end portion comprising an opening into the cavity/channel, and
an electrically conducting cap portion in the cavity/channel and adjacent to the shoulder portion.

26. A method of manufacturing a battery, the method comprising:
(1) providing a charge holding laminate comprising at least an anode layer, a cathode layer and a separator layer provided between the anode layer and the cathode layer, wherein, in a cross section of the laminate:
the separator forms a U- or V-shaped structure inside which the cathode layer is provided and
the anode layer is provided on both sides of the separator and extend farther in the direction of the bottom of the U- or V-shaped structure than the separator and;
(2) folding or bending the laminate;
(3) providing the folded/bent laminate in a casing having a first and a second electrical terminal;
(4) connecting the cathode layer to the first electrical terminal of the casing and the anode layer to the second electrical terminal of the casing.

27. The method according to claim 26, wherein the first and/or folding provides the anode layer outside of the separator and the cathode layer.

28. The method according to claim 26, wherein step 3 comprises:
providing the folded/bent laminate in a casing having a central portion having a cavity or channel with a longitudinal axis and a predetermined cross-sectional area in a plane perpendicular to the axis and
providing the folded/bent laminate into the cavity/channel through an opening at one end thereof and
the method further comprising the step of blocking the opening with a cap portion forming the first electrical terminal.

29. The method according to claim 28, wherein the cap portion forms one of the first and second terminal.

30. The method according to claim 29, wherein an opposite end portion of the casing forms the other of the first and second terminal.

31. The method according to claim 30, further comprising providing an electrically, resilient material between the other of the cathode layer and the anode layer and the opposite end portion of the casing.

32. The method according to claim 26, further comprising the step of providing one or more tab portions extending from at least one of the cathode layer and the anode layer.

31. The method according to claim 26, wherein step 4 comprises providing a casing comprising an inner channel or cavity closed at one end by an electrically conducting cap portion electrically connected to a layer of the laminate and a casing portion,
wherein the step of providing the casing portion comprises:
providing a first portion part with a first opening, the first opening opening into the cavity,
providing a first material on the first portion part, the first material extending from the first opening,
providing a second material on the first portion part and the first material and with a second opening at the first material, the second opening opening toward the surroundings of the battery.
